(19) United States
(12) Patent Application Publication
(10) Pub. No.: US 2006/0181964 A1
(43) Pub. Date: Aug. 17, 2006

(54) Method and device for determining write parameters for recording information on a record carrier

(76) Inventors: Willem M. J. M. Coene, Eindhoven (NL); Johannes Wilhelmus Maria Bergmans, Eindhoven (NL); Albert Hendrik Jan Immink, Eindhoven (NL); Christopher Busch, Eindhoven (NL); Alexander Marc Van Der Lee, Eindhoven (NL); Andries Pieter Hekstra, Eindhoven (NL); Aloysius M.J.M Spruijt, Eindhoven (NL); Johannes Martinus De Ruijter, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/564,536

(22) PCT Filed: Jun. 30, 2004
(86) PCT No.: PCT/IB04/51067

§ 371 Date: Jan. 12, 2006

(30) Foreign Application Priority Data
Jul. 14, 2003 (EP) 03102143.9
Oct. 16, 2003 (EP) 03103830.0

(51) Int. Cl. G11B 21/08

(52) U.S. Cl. 369/30.01

(57) ABSTRACT

The present invention relates to a method of determining write parameters for recording information on a record carrier, said information being in the form of a multidimensional channel data stream to be recorded as a channel band of at least two symbol rows one-dimensionally evolving along a first direction and aligned with each other along a second direction. In particular in the case of a read-only optical record carrier (ROM), for determining pit-hole sizes as the write parameters of pit-bits to be mastered on a ROM disc, the write parameters for recording a pit-symbol of a symbol unit of said channel data stream, a symbol unit comprising a central symbol and a number of neighbouring symbols of which some are located on the same symbol row as the central symbol and others are located on neighbouring symbol rows, are determined under joint consideration of The present invention relates to a method of determining write parameters for recording information on a record carrier, said information being in the form of a multidimensional channel data stream to be recorded as a channel band of at least two symbol rows one-dimensionally evolving along a first direction and aligned with each other along a second direction. In particular in the case of a read-only optical record carrier (ROM), for determining pit-hole sizes as the write parameters of pit-bits to be mastered on a ROM disc, the write parameters for recording a pit-symbol of a symbol unit of said channel data stream, a symbol unit comprising a central symbol and a number of neighbouring symbols of which some are located on the same symbol row as the central symbol and others are located on neighbouring symbol rows, are determined under joint consideration of (ii) the symbol values of the neighbouring symbols of the symbol unit located in the same symbol row as the central symbol of the symbol unit; and (iii) the symbol values of neighbouring symbols of the symbol unit located in the symbol rows that are neighbouring the symbol row of the central symbol of the symbol unit. Further, an iterative procedure for determining the write parameters is proposed.

The present invention relates to a method of determining write parameters for recording information on a record carrier, said information being in the form of a multi-dimensional channel data stream to be recorded as a channel band of at least two symbol rows one-dimensionally evolving along a first direction and aligned with each other along a second direction. The present invention relates further to a method and a corresponding device for determining write parameters for recording information on a record carrier, said information being in the form of a channel data stream to be recorded as a channel band of at least one symbol row one-dimensionally evolving along a first direction, wherein the write parameters are determined by an iterative procedure. The present invention relates further to a recording method and a corresponding recording apparatus for recording information in the form of a channel data stream on a record carrier. Still further, the present invention relates to a computer program for implementing said methods and to a record carrier.

The record carrier can generally be based on magnetic recording principles or on optical recording principles. The further description focuses in more detail on an optical record carrier, which, however, does not exclude other types of record carrier.

Generally, for the 2D optical recording channel as a whole, that is, being the combination of the write-channel at the transmitting end of the channel and the read-channel at the receiving end of the channel certain properties shall be achieved. One main goal is linearization of the channel. It is assumed that the read-channel is more or less fixed by the characteristics of central aperture (CA) detection, i.e. the detection mode commonly used in 1D optical recording (see e.g. J. Braat, “Read-out of Optical Disks”, in “Principles of Optical Disc Systems”, Adam Hilger Ltd, 1985, pp. 7-87.). Non-linear characteristics of the read-channel have to be compensated by proper measures taken at the side of the write-channel: this is known as write-precompensation, implemented via a write-strategy. The channel symbols (bits or, more generally, M-ary symbols) are processed through a so-called (non-linear) transmit filter to generate the parameters for the physical write-channel. In case of (small) deficiencies in the write-strategy leading to an incomplete linearization, the remaining non-linearities can be dealt with by a complementary receiving filter (via a non-linearity compensation). An appropriate write-strategy for 2D optical storage, in particular for ROM media, is therefore desired. Further, also specific measures for a write-strategy in recordable and/or re-writable 2D optical storage are required.

A write-strategy procedure that realizes a first desired property of the high-frequency (HF) signal values that are detected in 2D modulation on (quasi-) hexagonal two-dimensional lattices of bits has been described in European patent application EP 02 076 255.5 (PHNL 020279). The “physical” detection is based on the principle of central aperture detection of the photon density incident on the photo-detector (PDIC). On the hexagonal lattice, a hexagonal cluster consisting of 7 bits, with one central bit and 6 (nearest) neighbour bits, is considered as a basic unit, also called symbol unit or bit cluster. The first desired property is that the HF signal values show a systematic roll-off with an increasing number of neighbour bits of the pit-type (“1 ”-bits): this property must hold for both possible bit-values for the central bit. When this property is not satisfied (e.g. for the pit-bits), the problem of signal folding has to be dealt with, which implies that (part of) the HF signal values increase (instead of decrease) with an increasing number of neighbour pit-bits (when the central bit is of the pit-type); moreover, in the case of maximum signal folding, which occurs when the bit-cell for a pit-bit consists of 100% “pit-area”, it implies that the HF signal for the all-land case is identical to the HF signal for the all-pit case (both behave as perfect mirrors).

Signal folding typically occurs when the pit-bits are physically mastered (in a ROM disc) such that the pit-area covers a large fraction of or even the complete area of a bit-cell (which is a hexagon, the fundamental cell of the 2D hexagonal lattice). The elimination of signal folding was achieved through the writing of (relatively much) smaller pit-holes than the ones that are maximally possible: a quite convenient roll-off of the signal values is achieved for a duty factor of 50%, that is, the pit-hole covers about half of the area of the available hexagon.

Apart from the above mentioned “first desired property”, a second additional desired property to be realized through an extended write-strategy shall be achieved. A variety of “second desired properties” can be thought of. A very likely candidate is that the HF signal values exhibit a signal variation that is typical for a linear response. Many candidate bit-detection schemes expect a linear response; since this type of bit-detectors cannot deal with channel non-linearities, some kind of (possibly memory-less) non-linearity compensation (NLC) has to be included prior to equalization and bit-detection. There are two disadvantages in the use of such an NLC circuit: firstly, the (memory-less) NLC suffers from its limited accuracy; and secondly, assuming that the noise distributions are level-independent, it is advantageous in view of limiting the influence of noise to spread the HF-signal values as much as possible over the available amplitude space: such a situation is not accomplished by the measures according to the “first desired property” since the signal levels for the “1”-bit are non-linearly compressed, resulting in non-equidistant signal levels prior to the NLC. The NLC operation will then result in noise distributions that are dependent on the signal level. Therefore, it is advantageous to incorporate a write-strategy that delivers “linear levels” (as linear as possible) at the output of the physical bit-detection on the photo-detector, prior to any signal processing: as a result, noise variances will be equal for each individual level.

A so-called PIP TM (Pre-compensation Iteration Process) write-strategy for use in multi-level (ML) (one-dimensional) optical recording has been disclosed in WO 01/57856. Therein, a dedicated write-strategy is based on a write-strategy matrix, which depends on the central symbol to be written, and a limited number of its neighbouring symbols. PIP is promoted as an adaptive ML write strategy, designed to remove the majority of non-linear channel effects. In particular, PIP makes data recovery more robust by reducing the overlap between the distributions of neighbouring signal levels, which is accomplished by decreasing the width of these distributions, and most importantly, by centering the distributions, making the levels of the multi-level system equidistant.

In a two-dimensional pattern, at a particular location exactly the same bit cluster (or symbol unit) and thus also the same cluster-class can appear. A write-strategy that is based on a write-strategy table or matrix, as disclosed in WO 01/57856 for a one-dimensional coding scheme, then yields exactly the same write-strategy parameter, for instance, exactly the same pit-hole radius. However, even if the bit cluster is identical, the bits surrounding the cluster can be different, so that individual bits of the bit cluster will have write parameters, e.g. pit-hole sizes, that are different from their nominal values. These local deviations from the nominal write parameters (pit-hole radii) will influence the optimal choice for the write parameters to be made at the central bit. This can be partly accounted for by extending the size of the write-strategy table, e.g. by inclusion of more rings or shells of neighbouring bits of the bit cluster. A fill account of this “chain-effect” of one bit influencing the choice of the write parameters of a neighbouring bit would be to have a very large write-strategy table, which is however impractical to work with.

It is an object of the present invention to provide a method and a corresponding device for determining the write parameters which can effectively be used for multi-dimensional coding schemes. It is a further object of the present invention to provide a method and a corresponding device for determining the write parameters which take into account the above described “chain-effect” preferably avoiding the use of a very large write-strategy table or matrix. Furthermore, an appropriate recording method and recording apparatus, computer program and a record carrier using the invention, shall be provided.

This object is achieved according to the present invention by a method as claimed in claim 1 wherein the write parameters for recording a pit-symbol of a symbol unit of said channel data stream, a symbol unit comprising a central symbol and a number of neighbouring symbols of which some are located on the same symbol row as the central symbol and others are located on neighbouring symbol rows, are determined under joint consideration of

(i) the symbol value of the central symbol of the symbol unit;

(ii) the symbol values of the neighbouring symbols of the symbol unit located in the same symbol row as the central symbol of the symbol unit; and

(iii) the symbol values of neighbouring symbols of the symbol unit located in the symbol rows that are neighbouring the symbol row of the central symbol of the symbol unit.

Contrary to the solution known from WO 01/57856 write parameters for recording a pit-symbol of a symbol unit depend not only on the neighbouring symbols in the same symbol row at which the symbol under consideration is located, but in addition, depend also on the neighbouring symbols in the symbol rows above or below the symbol row at which the symbol under consideration is located. Thus, symbol values of symbols in neighbouring symbol rows determine partly the write parameters of a symbol in a given row, in order to achieve characteristics of the HF-signal of said symbol in said given row.

In an embodiment of the invention the write parameters are determined by use of a parameter table containing the write parameters for all possible classes of symbol units, from which the write parameters for recording a pit-symbol at the central symbol of the symbol unit are selected according to the actual said symbol unit. For each value of the central symbol, and for each of the possible environments (of neighbouring symbols) of that central symbol, an entry in the parameter table (also called write-strategy matrix), which yields a set of (at least one) write strategy parameter(s) for the central symbol of the symbol unit under consideration to be used in the physical write-channel. Instead of a single write strategy matrix a set of write-strategy matrices (preferably in a rewritable system) can be used, for instance, when the write-strategy involves more than one physical parameter; another application with a set of write-strategy matrices relates to the case where each matrix is devised for one physical condition of the write-channel (for instance, like tilt of the writing laser-spot, relative to the disc).

The object underlying the invention is further achieved according to the present invention by a method as claimed in claim 4 comprising the steps of:

setting the write parameters for recording pit-symbols of said channel data stream to preliminary parameter values,

updating the preliminary parameter values by searching for the updated parameter values that best fulfil a predetermined criterion for the write parameters for recording of pit-symbols, said criterion being determined by the difference of HF-signal values, which will be determined by use of a channel model or obtained during read-out of pit-symbols recorded by use of the updated parameter values (that are updated in a previous iteration), and reference HF-signal values,

iterating said updating until a predetermined condition is fulfilled.

According to this second embodiment of the present invention a write-precompensation through an “on-the-fly” (iterative) computational procedure is proposed that operates sequentially for a sequence of channel symbols, preferably in (roughly) the order at which these symbols have to be written to the record carrier: the write parameters of a current channel symbol are derived from the (already determined) write parameters of (a limited set of) previous channel symbols together with the write parameters of (a limited set of) future channel symbols. For these future symbols, an average (preliminary) write parameter is set, at least in the first iteration of the described procedure. In next iterations, for the future channel symbols the write parameters that are obtained during the previous iteration can be used to update the current channel symbol. The write parameters for a cluster of symbols will thus be determined not only by the composition of that cluster, but also to some extent by the history (memory) of the preceding sequence of channel symbols that leads to the considered cluster at a given position along the sequence of channel symbols, via the values of the write parameter that has been set at the channel symbols of that preceding sequence.

The present invention is preferably applied for 2D optical recording where the information is in the form of a channel data stream to be recorded as a channel band of at least two symbol rows one-dimensionally evolving along a first direction and aligned with each other along a second direction, said two directions constituting a two-dimensional lattice of symbol positions. However, the invention is generally applicable, i.e. it can be applied also for multi-dimensional recording where data are arranged along a 3D (or theoretically higher-dimensional) array.

Corresponding devices which are adapted for carrying out said methods are defined in claims 14 and 15. A recording method and a corresponding recording apparatus in which pit-symbols are recorded by use of write parameters which are determined by a procedure as defined above are claimed in claims 16 and 17. A computer program comprising program code means for causing a computer to perform the steps of the above methods when said computer program is executed on a computer is defined in claim 18.

Preferred embodiments of the invention are defined in the dependent claims. The predetermined criterion to be fulfilled for the write parameters is preferably determined by the sum of absolute values of the differences of the so-called “read-out” HF-signal values which are the HF-signal values obtained from or to be obtained from read-out, and the so-called reference HF-signal values or by the sum of squared differences of said read-out HF-signal values and said reference HF-signal values. Preferably, said sum comprises squared differences for all pit-symbols and non-pit symbols (or “land” symbols) in a particular symbol area and said sum shall be minimized during updating.

According to further embodiments of the invention it is proposed that the predetermined condition is that the write-parameter for each pit-symbol has been updated for a predetermined number of times or that is has reached a value below a predetermined threshold value, so that the predetermined condition is a quality measure or figure-of-merit.

The reference HF-signal values are obtained from a hypothetical ideal signal which would result for a linear channel, that is a channel that can be represented by a linear (two-dimensional) impulse response. For the read-out HF-signals on the other hand, in practice a finite number of write parameters will be used for which the resulting HF-signal values are determined in advance based on a computational model that represents well the experimental signal generation in the read-channel. Then, with a proper minimization procedure as defined above, the set of write parameters that gives the best match between the “read-out” HF signals (obtained from the computational model for the signal generation) and the (linear) reference HF-signal values can be found. For a finite number of write parameters, such a minimization procedure could be solved with a dynamic programming approach just like the Viterbi algorithm as is used for bit-detection in the read┤ ▪ enormous complexity aspects related to an M-ary Viterbi in case of many possible pit-hole sizes for the write-parameter, it is preferred according to the present invention that a low-complexity and slightly sub-optimal optimization procedure is used for realizing the match that is concerned with the best set of write parameters that realize the closest match between the targeted linear HF-signal values and the “read-out” HF-signal values that can be either computed for the write parameter set derived from the computational channel model, or the “read-out” HF-signal values that can be directly measured when the write-parameters have been adopted for writing the symbols in an Iterative writing experiment.

As already described above the “read-out” HF-signal values and the reference HF-signal values are determined on the basis of symbol units, also called bit or symbol clusters, each symbol unit comprising a central symbol and a number of neighbouring symbols, in particular a number of nearest neighbouring symbols surrounding the central symbol. Such a symbol unit can, for instance, be a hexagonal cluster comprising one central symbol and 6 surrounding symbols at a nearest neighbour distance. Alternatively, a squared cluster can be used comprising one central symbol and 4 nearest neighbouring symbols. For the case of the hexagonal cluster, two of the 6 nearest neighbour symbols are located in the same symbol row as the central symbol, and the other four nearest neighbour symbols are located in neighbouring symbol rows.

Furthermore, for the iterative procedure of the second embodiment, it is preferred that the preliminary write parameter values for the pit-symbols set in the first step of the method are derived from a parameter table containing the write parameters for all possible classes of symbol units (with a central pit-symbol). Alternatively, assuming a channel with binary modulation, to all pit-symbols the same fixed write parameters could be assigned prior to the first iteration.

According to a preferred embodiment of the second embodiment comprising the iterative procedure, the iterative optimization procedure according to the present invention is based on a sliding window approach according to which in said updating step of the iteration the write parameters of the pit-symbols to be updated are updated subsequently symbol column by symbol column for a number of symbol columns defining a detection window, wherein the detection window is shifted after each iteration by at least one column in the tangential direction of the broad spiral which comprises a number of bit-rows aligned with each other in the second direction, whereby the write parameters of symbols in a new column that enters the detection window after sliding are set to initial predetermined values, and wherein the iterations are repeated for a given column until said column is shifted outside of said detection window. This is a simple sequential procedure for updating the write parameters which can be easily implemented.

The write parameters to be determined according to the present invention mainly depend on the type of record carrier to be used. For a read-only (ROM) record carrier, the pit-hole size needs to be determined which is realized during mastering by applying a certain laser intensity for illumination of a photo-resist layer. For a rewritable record carrier, based on phase-change technology, a certain amorphous region is realized by a series of laser pulses at well defined laser powers. Thus, instead of pit-hole size the more direct physical parameters that yield a given pit-hole size can be determined, such as the characteristics of write pulses, in particular the number, the duration and/or the power level of a plurality of write pulses, or, in a more simple case, the power level of a single write pulse.

A record carrier on which pit-symbols have been recorded by use of the method according to the present invention is defined in claim 19. It can be seen from the record carrier, for instance by use of a SEM, TEM or AFM image, whether the pit-hole sizes are all the same, independent of the bit cluster type or whether they are different depending on a cluster. In the latter case, it is even possible to distinguish between two cases: in a first case all clusters that occur for one cluster type lead to the same pit-hole size, which indicates that a write strategy matrix or table has been used. In a second case, clusters that occur for one cluster type may lead to slightly different pit-hole sizes because an updating strategy is used according to the present invention. In order to recognize whether the variation is random or according to a particular update strategy, the 2D correlation properties of the pit-hole sizes of a given cluster type can be evaluated as a function of its neighbouring symbols which then indicates that the second embodiment of the present invention has been used to determine the pit-hole sizes.

The present invention will now be explained in more detail with reference to the drawings in which

FIG. 1 shows a block diagram of a general layout of a coding system,

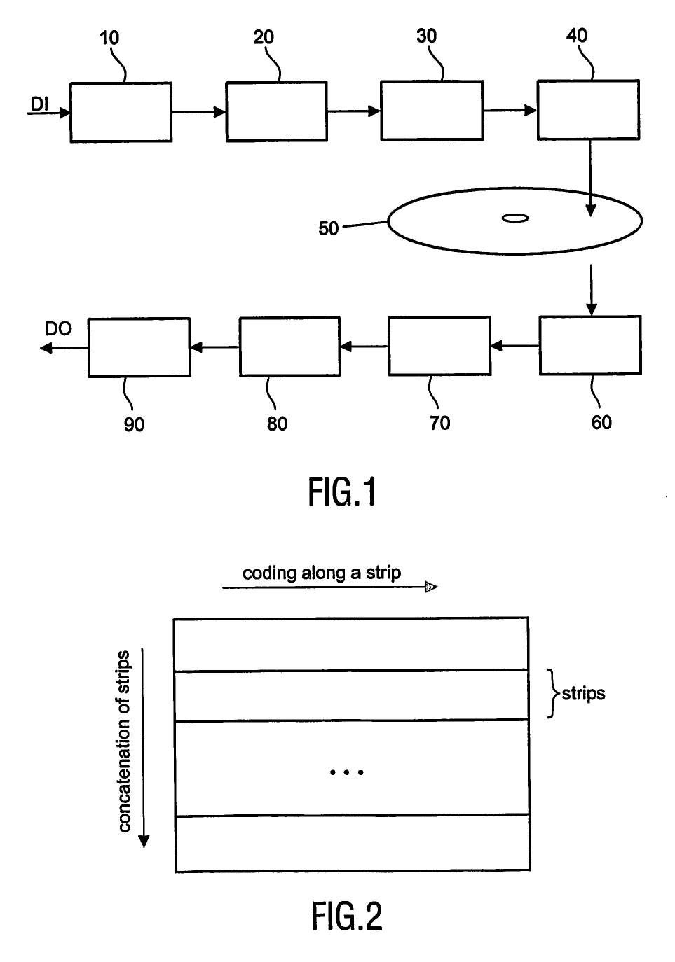

FIG. 2 shows a schematic diagram indicating a strip-based two-dimensional coding scheme,

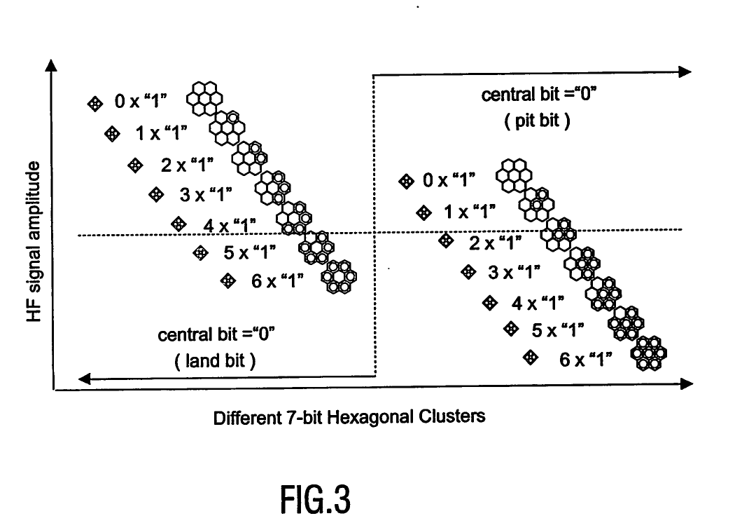

FIG. 3 shows a schematic signal-pattern for a two dimensional code on hexagonal lattices,

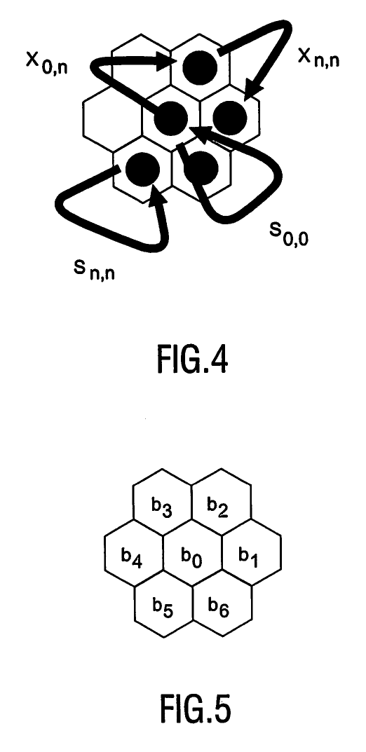

FIG. 4 illustrates two types of bi-linear interferences in a hexagonal cluster,

FIG. 5 shows a hexagonal bit cluster as used according to the present invention,

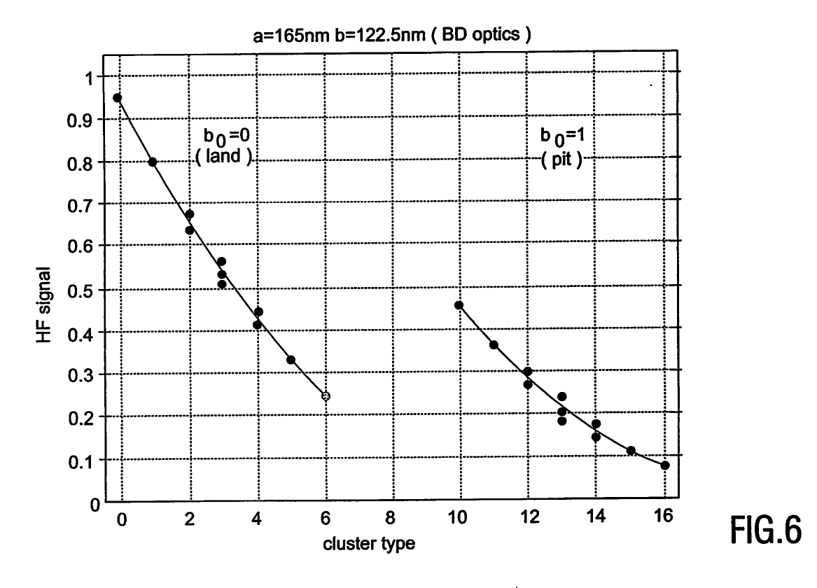

FIG. 6 shows the HF-signal pattern as a function of the cluster type,

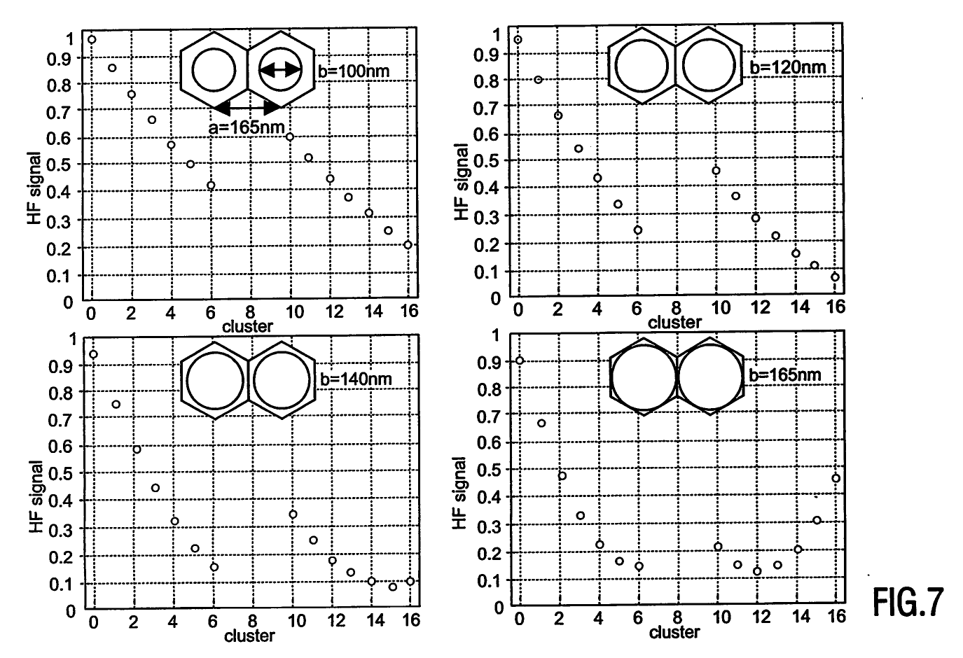

FIG. 7 shows HF-signal patterns as a function of the cluster type for 2D modulation on a hexagonal lattice for various fixed pit-hole sizes,

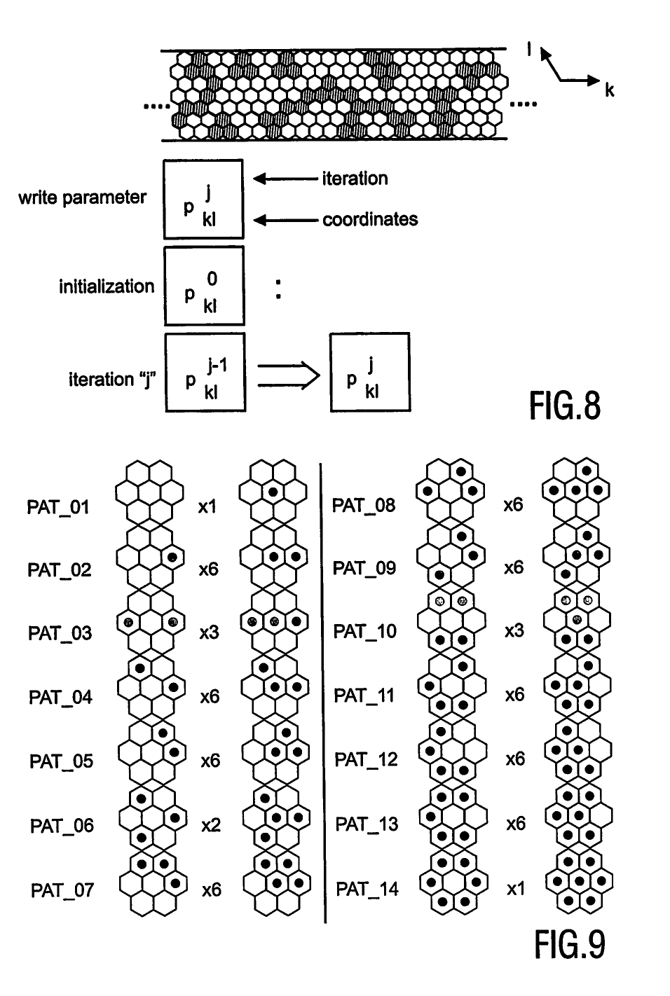

FIG. 8 shows a schematic diagram for an iterative method according to the invention,

FIG. 9 shows the basic cluster classes for a 7-bit hexagonal cluster,

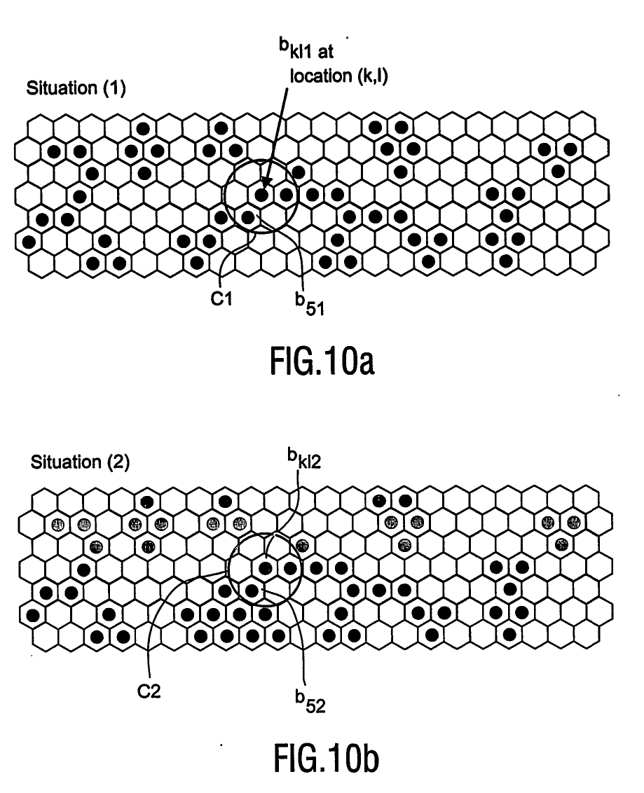

FIG. 10 illustrates the problem underlying the present invention,

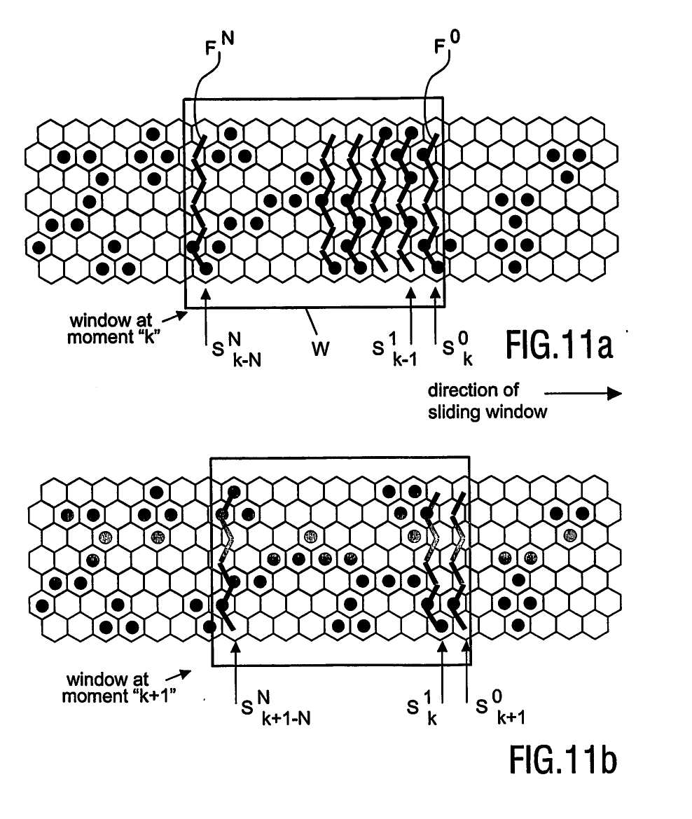

FIG. 11 illustrates the sliding window implementation of the present invention,

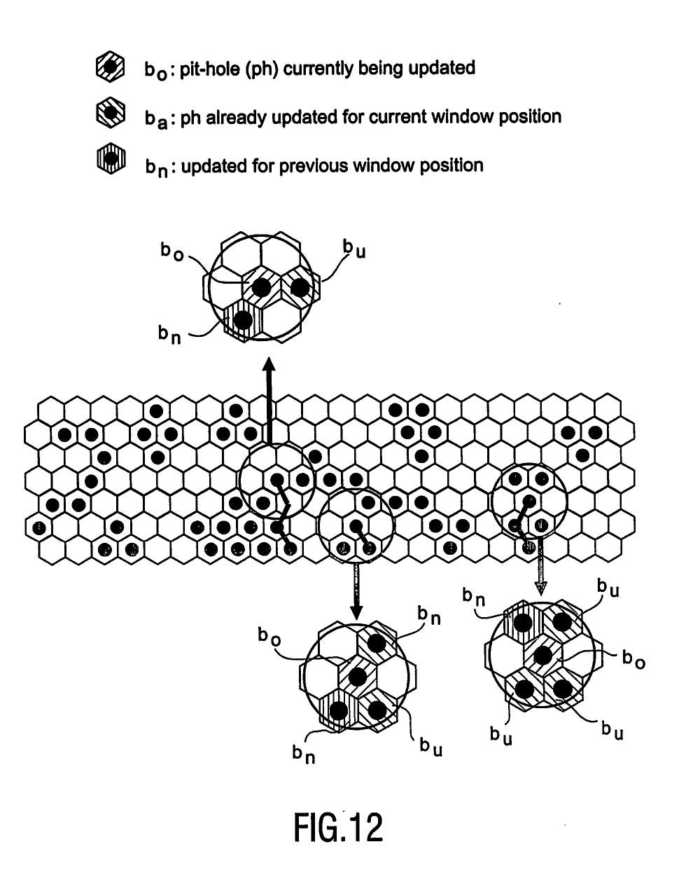

FIG. 12 illustrates the method of the present invention in more detail,

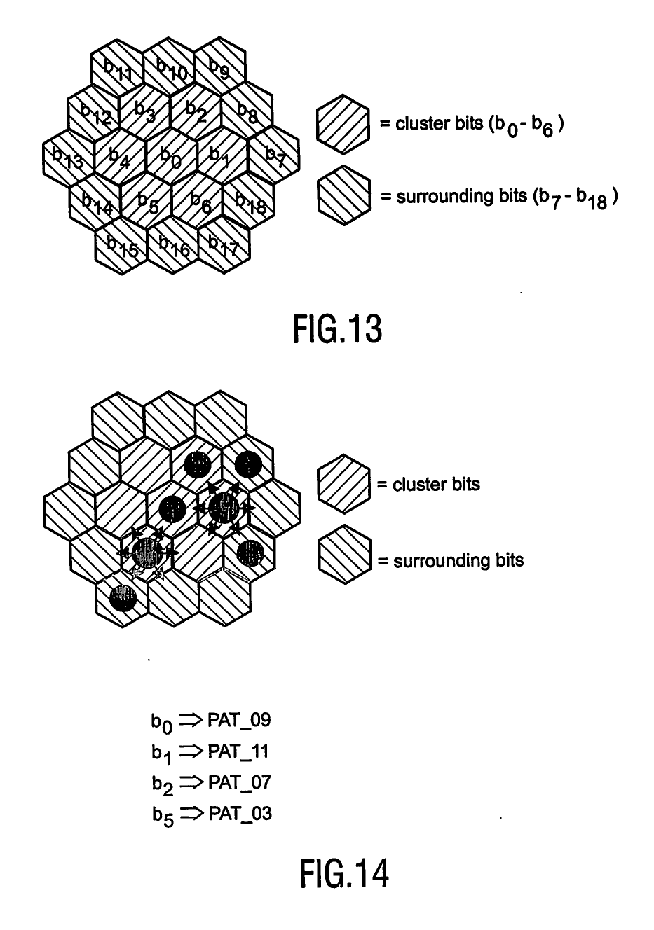

FIG. 13 shows a 7-bit hexagonal cluster with 12 surrounding bits beyond the first shell of nearest neighbour bits,

FIG. 14 shows the cluster classes for the 7-bit cluster shown in FIG. 13, and

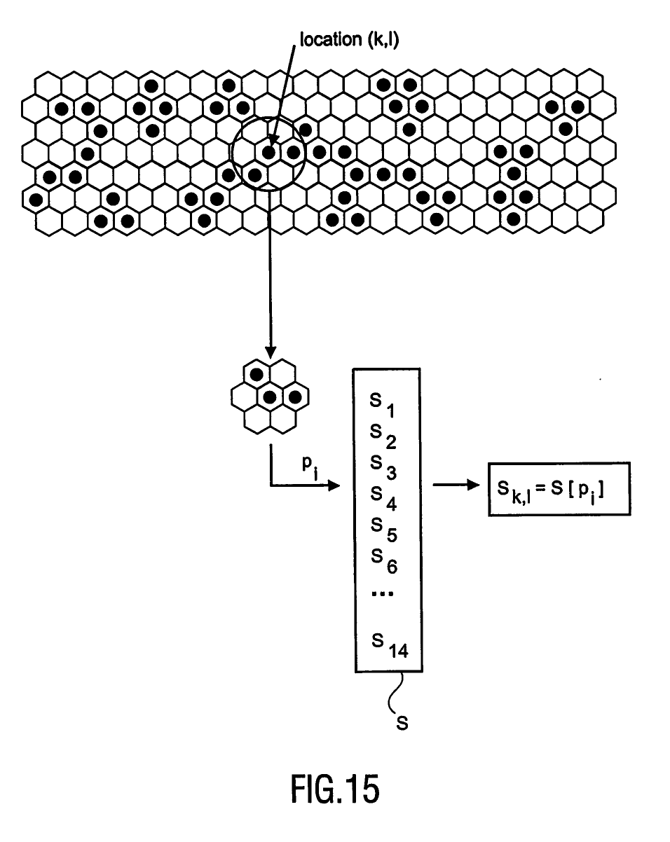

FIG. 15 shows a schematic diagram of another embodiment of method according to the invention.

FIG. 1 shows typical coding and signal processing elements of a data storage system. The cycle of user data from input DI to output DO can include interleaving 10, error-correction-code (ECC) and modulation encoding 20,30, signal preprocessing 40, data storage on the recording medium 50, signal post-processing 60, binary detection 70, and decoding 80, 90 of the modulation code, and of the interleaved ECC. The ECC encoder 20 adds redundancy to the data in order to provide protection against errors from various noise sources. The ECC-encoded data are then passed on to a modulation encoder 30 which adapts the data to the channel, i.e. it manipulates the data into a form less likely to be corrupted by channel errors and more easily detected at the channel output. The modulated data are then input to a recording device, e.g. a spatial light modulator or the like, and stored in the recording medium 50. On the retrieving side, the reading device (e.g. photo-detector device or charge-coupled device (CCD)) returns pseudo-analog data values which must be transformed back into digital data (one bit per pixel for binary modulation schemes). The first step in this process is a post-processing step 60, called equalization, which attempts to undo distortions created in the recording process, still in the pseudo-analog domain. Then the array of pseudo-analog values is converted to an array of binary digital data via a bit detector 70. The array of digital data is then passed first to the modulation decoder 80, which performs the inverse operation to modulation encoding, and then to an ECC decoder 90.

In the European patent application EP 01 203 878.2 the 2D constrained coding on hexagonal lattices in terms of nearest-neighbour clusters of channel bits is described. Therein, it has been focussed mainly on the constraints with their advantages in terms of more robust transmission over the channel, but not on the actual construction of such 2D codes. The latter topic is addressed in the European patent application 02 076 665.5 (PHNL 020368), i.e. the implementation and construction of such a 2D code is described therein. By way of example, a certain 2D hexagonal code shall be illustrated in the following. However, it should be noted that the general idea of the invention and all measures can be applied generally to any 2D code, in particular any 2D hexagonal or square lattice code. Finally, the general idea can also be applied to multi-dimensional codes, possibly with isotropic constraints, characterized by a one-dimensional evolution of the code in a certain direction.

As mentioned, in the following a 2D hexagonal code shall be considered. The bits on the 2D hexagonal lattice can be identified in terms of bit clusters. A hexagonal cluster consists of a bit at a central lattice site, surrounded by six nearest neighbours at the neighbouring lattice sites. The code evolves along a one-dimensional direction. A 2D strip consists of a number of 1D rows, stacked upon each other in a second direction orthogonal to the first direction, and forming an entity over which the 2D code can evolve. The principle of strip-based 2D coding is shown in FIG. 2. Several strips that are coherently stacked one upon the other forms a broad two-dimensional band, which can be spiralled on an optical disc (such a band is also called a “broad-spiral”). Between successive revolutions of the broad spiral, or between neighbouring 2D bands a guard band of, for instance, one (empty) bit-row (filled with zero-bits, and are thus equal to land-marks) may be located.

The signal-levels for 2D recording on hexagonal lattices are identified by a plot of amplitude values of the HF-signal for the complete set of all hexagonal clusters that are possible. Use is further made of the isotropic assumption, that is, the channel impulse response is assumed to be circularly symmetric. This implies that, in order to characterize a 7-bit cluster, it only matters to identify the central bit, and the number of “1”-bits (or “0”-bits) among the nearest-neighbour bits (0, 1, . . . , 6 out of the 6 neighbours can be a “1”-bit). A “0”-bit is a land-bit in our notation. A typical “signal-pattern” is shown in FIG. 3. Assuming a broad spiral consisting of 11 parallel bit rows, with a guard band of 1 (empty) bit row between successive broad spirals, the situation of FIG. 3 corresponds to a density increase with a factor of 1.7 compared to traditional 1D optical recording (as used in e.g. in the Blu-ray Disc (BD) format (using a blue laser diode with a wavelength of 405 nm, and a lens with a numerical aperture of NA=0.85).

The basic origin of the channel non-linearity is the fact that the detected signal is related to the photon probability at the photo-detector. The photon probability is modeled (in scalar diffraction theory) as the squared modulus of the (complex-valued) photon wave function (which describes the interaction of the possibly aberrated wavefront of the photon with the phase- and amplitude-structures on the optical disc constituted by the pits and lands). The relation between the photon wave function and the bits written on the disc is (at least) a linear one. Therefore, the relation between the photon probability function and the bits is (at least) a bi-linear one, the terminology bi-linear being used here to indicate a non-linearity of second order.

For the sake of completeness, it is to be noted that the photon probability function is further integrated over the photo-detector: this yields the so-called central aperture signal, referring to the (mathematically equivalent) integration of the photon probability in the plane of the (exit) pupil. The channel model yields linear and bi-linear terms. Among the bi-linear terms, self-interference terms for each pit bit (close enough to the center of the illuminating spot), and cross-interference terms for each two-bit pair (with both pit-bits within the area of the illuminating spot) are obtained. These bi-linear terms are illustrated in FIG. 4. The cross-interference terms become quite small when the distance between both pit-bits of the pit-pair is larger than the nearest-neighbour distance of the hexagonal lattice (which is equal to the hexagonal lattice parameter denoted by a): it is therefore a good approximation (especially for intermediate densities) to consider only nearest-neighbour cross-interferences.

If the interferences of the channel are further limited to the bits of the 7-bit hexagonal cluster, the HF signal can be modeled to a very good approximation as (assuming for simplicity a pit-depth with single-pass phase modulation equal to π/2, for maximum modulation in the central aperture signal; and assuming a fixed pit-hole radius for all pit-bits):

HF=1-4b₀(l₀−s_{0,0})−4n(lₙ−s_{n,n})+8nb₀x_{0,n +}8pₙx_{n,n}.

This is essentially a 4-parameter model (one parameter for each term). The parameters and variables have the following interpretation:

n: number of nearest-neighbours (of the central bit) being of the pit-type;

b₀: bit-value of the central bit (“1” for pit, “0” for land);

l₀: tap-value of linear interference for central bit;

lₙ: tap-value of linear interference for (nearest) neighbour bit;

s_{0,0}: value for self-interference of central pit-bit;

s_{n,n}: value for self-interference of (nearest) neighbour pit-bit;

x_{0,n}: value of cross-interference between central pit-bit and (nearest) neighbour pit-bit;

x_{n,n}: value of cross-interference between two (nearest) neighbour pit-bits (neigbors of the central bit), which are also nearest neighbours of each other;

pₙ: number of (nearest) neighbour pit-pairs among the (nearest) neighbour bits.

The possible values of the parameter pₙ (and its average value<pₙ>) are shown for different values of the number of nearest-neighbour pit-bits n in the following table:

| n | # of Neighbour Pit-Pairs (pₙ) | <pₙ> |
|---|---|---|
| 0 | 0 | 0 |
| 1 | 0 | 0 |
| 2 | 0, 1 | 0.4 |
| 3 | 0, 1, 2 | 1.2 |
| 4 | 2, 3 | 2.4 |
| 5 | 4 | 4 |
| 6 | 6 | 6 |

The above equation holds only for a fixed pit-hole radius for all pit-bits. If a varying pit-hole radius is allowed, then a generalized form of the above equation should be used instead, which reads as:

$$\begin{matrix}HF = 1 - 4 {b}_{0} ( {l}_{0} [ {S}_{0} ] - {s}_{0 , 0} [ {S}_{0} ] ) - \\ 4 {\sum }_{i = 1}^{6} {b}_{i} ( {l}_{n} [ {S}_{i} ] - {s}_{n , n} [ {S}_{i} ] ) + \\ 8 {\sum }_{i = 1}^{6} {b}_{0} {b}_{i} {x}_{0 , n} [ {S}_{0} , {S}_{i} ] + \\ 8 {\sum }_{i = 1}^{6} {b}_{i} {b}_{i + 1} {x}_{n , n} [ {S}_{i} , {S}_{i + 1} ] )\end{matrix}$$

where the same terminology has been used as in the above equation, but with explicit reference to the pit-hole surfaces indicated by Sᵢ for the pit-surface of pit-bit i. The indexing system of the bits on the hexagonal cluster is shown in FIG. 5 (and it is assumed that b₇ is again identical to b₁).

FIG. 6 shows the HF signal pattern for a =165 nm and pit-diameter b=122.5 nm. From the plot, the 11 different signals according to the number of different pₙ parameters can be clearly observed. The average HF signal value (indicated by the solid line in FIG. 6) is obtained as the average over all clusters with a given value of n (between 0 and 6). This average value is determined by the value of <pₙ>, which is listed in the third column of the above table. Since x_{n,n} is a positive number, the graph shows an upward curvature for the higher values of n (for both cases: b₀=0 and b₀=1). Thus, in conclusion, there are two basic types of non-linearity in this model. Firstly, there is the non-linearity associated with the cross-interference x_{n,n} which is governed by pₙ. Secondly, there is the non-linearity associated with the cross-interference x_{0,n} which depends on the number of pit-pairs that contain the central (pit-) bit and the pit-bits among the (nearest) neighbours of the central bit (which number is defined as n): so the pre-factor of x_{0,n} is proportional to the product nb₀. Since x_{0,n} is a positive number, the second type of non-linearity (the 4th term in the right-hand-side of the above equation) boils down to a different (less negative) slope of the linear interferences for the case where the central bit b₀=1 as compared to the case where b₀=0.

In the above mentioned European patent application 02 076 255.5 (PHNL 020279) the use of a single radius for the pit-holes, irrespective of the type of cluster that the corresponding central pit-bit belongs to, is proposed as a satisfactory means against signal folding, in particular on a ROM disc. In FIG. 7 the HF-signal patterns for various (fixed) sizes (diameters b) of the mastered pit-holes can be seen for a hexagonal lattice parameter a=165 nm and for a series of fixed pit-hole diameters of b=100 nm, 120 nm, 140 nm and 165 nm. The HF-signals have been obtained through a scalar diffraction model tailored to the 2D hexagonal lattice.

FIG. 8 illustrates the basic principle of the method according to the second embodiment of the current invention using the iterative procedure. At the input, the 2D bit-pattern that has to be written to the disc is provided. For each bit location (denoted by coordinates (k,l)), the information of the bit-cluster consisting of the central bit and its neighbour bits is retrieved. In a initialisation step the write parameters p_{Id}⁰ of the (non-zero) bits bₖₗ are set to a preliminary value, e.g. a fixed write parameter (e.g. pit-hole size) or obtained from a table or matrix. Thereafter, these preliminary values are updated in an iterative procedure.

The bit-cluster that is referred to may consist of the central bit plus a number of shells consisting of neighbour bits all at the same distance from the central bit. The simplest case is the one with only one shell (containing the nearest neighbour bits), yielding 7-bit clusters. This one-shell case seems to be quite accurate for moderate to even relatively high recording densities in 2D optical recording. Therefore, it is treated in more detail in the following, as a representative but specific example.

In principle, the write-strategy could be devised for any symmetry present in the read-out spot (like an elliptic shape). For simplicity's sake from now on isotropic (read-) channel characteristics, implying a read-channel with a circularly-symmetric symmetry, or at least a symmetry compatible with the hexagonal (rotation) symmetry of the 2D bit-lattice are considered. The basic (or independent) cluster classes for this case are now derived: a cluster class comprises all clusters that can be transformed one into another by means of rotation over 60, 120, 180, 240 or 300 degrees. It turns out that there are 28 of such independent cluster classes, 14 with the central bit value b₀ equal to 0, and 14 with b₀ equal to 1 (considering only a non-zero pit-hole radius for pit-bits, having bit-value b₀=1). These basic cluster classes are denoted in FIG. 9 as PAT-01, PAT-02, . . . , PAT-14. In order to describe the different cluster classes, we have adopted the convention as shown in FIG. 9. For each cluster class, its multiplicity (denoted by xi) is indicated by the number “i” which is the number of clusters that belongs to a given cluster class. It should be noted that the (rotation variants of) classes PAT-08 and PAT-09 can be transformed one into another by point inversion (with the centre of inversion located in the centre of the cluster). So, if the inversion symmetry is added then the number of distinct cluster classes reduces to 13 (PAT-08 and PAT-09 becoming degenerate). A next reduction in number of distinct classes is possible if only next-neighbour non-linearities for x_{0,n} are taken into account. Then, classes PAT-03 and PAT-04 become degenerate; the same holds for classes PAT-10 and PAT-11. Thus the number of distinct classes has become equal to 11. A further (and still more severe) reduction to only 7 distinct classes is possible if only the number of neighbour pit-bits n as a relevant parameter is considered.

The problem underlying the present invention shall now be illustrated with reference to FIG. 10. At location (k,l) for the two situations indicated by a circle exactly the same cluster C1, C2 and thus also the same cluster-class is found as shown in FIG. 10a and FIG. 10b. A write-strategy that would be based on a write-strategy table or matrix would yield exactly the same write parameters.

However, in situation (2) shown in FIG. 10b, the pit-bit b₅₂ at 7:30 in the circle is surrounded by three + one (the central bit of the cluster C2) pit-bits, whereas in situation (1) shown in FIG. 10a, the same pit-bit b₅₁is only surrounded by one+one pit-bit. A situation with no pit-neighbours for that bit outside of the circle determining the cluster-class is also possible.

The bit b₅₁ and b₅₂, respectively, will thus have a different pit-hole size, or more generally, different write parameters for both situations. These different sizes will influence the optimal choice for the pit-hole size to be made at the central bit bₖₗ. This can be partly accounted for by extending the size of the write-strategy table, e.g. by inclusion of more rings or shells of neighbouring bits (making the circle drawn larger and larger). A full account of this “chain-effect” of one pit-hole influencing the choice of a neighbouring pit-hole would be to have a very large write-strategy table, which is however impractical to work with.

It is thus proposed according to the present solution to perform an “on-the-fly” optimization of the pit-hole sizes, taking into account the above “chain-effect”. Instead of pit-hole sizes (for ROM), it is also possible to optimize any set of parameters on which the write-channel (e.g. a set of laser-pulses with for each pulse a certain duration and a certain laser power, for phase-change recording) may be based, such as the power level or number of write pulses.

For the following explanation it shall be supposed that there are L possible values for the pit-hole size of a pit-bit, that the memory of the read-channel (that is, the extent of the ISI) amounts to M fish-bones (one column or zig-zag pattern of channel symbols in the radial direction in the channel strip shown in FIG. 11) at each side of a current fish-bone (total memory is 2M) and that there are N_{row} bit-rows within one channel strip. Then, the optimization of the write-strategy proposed according to the present invention, based on a quantitative figure-of-merit, is a dynamic programming problem, just like the standard Viterbi-problem. Optimization then means finding the best path (with the lowest cost, or lowest value of the Figure-of-Merit) through a trellis of states: the number of different states amounts to L^{Λ}(2 M N_{row}). This number is a maximum, since some states may be forbidden, because land-bits have always a zero pit-hole size which does not need optimization.

However, instead of “exactly” solving the above optimization procedure with the use of the Viterbi algorithm, it is proposed to use an iterative procedure. As an example the optimization parameters are the pit-hole sizes of all pit-bits. The optimization criterion (or, Figure-of-Merit, FoM) reflects the intention to adopt the overall response of the channel (write-channel and read-channel) to a certain specified target-response. A convenient target-response (in view of a bit-detector) could be a linear one. A preferred embodiment of a FoM to be used is:
FoM =Σₖₗ ]HF_{channel} (bₖₗ +neighbouring bits)−HF_{target} (bₖₗ +neighbouring bits)]².

In the above equation, the first set of HF-values are the so-called “read-out” HF-signal values, and the second set of HF-values are the so-called “reference” HF-signal values.

The figure-of-merit should be made small enough by the write-strategy optimization. The FoM is the sum of squared values of the deviations of a target signal waveform HF<target> (which can be a linear target, but it can also be a non-linear target in order to use a larger portion of the signal amplitude range in the area of signal overlap in the 2D signal pattern, said overlap occurring between the signal levels for the clusters where the central bit is a “0” and the signal levels for the clusters where the central bit is a “1”) subtracted from the signal waveform that results from a computational model (or, equivalently, could be measured experimentally) for a given set of pit-hole sizes (that have been defined for the central pit-bit and its neighbour pit-bits).

Optimization is done on the basis of a sliding window as shown in FIG. 11. A rectangular window W is chosen as a practical example. The window W comprises all bit-rows in the two-dimensional broad spiral. Its lateral (or tangential) extent is a number of (N+1) fish-bones.

Supposing the (one-sided) tangential extent of the ISI (in one direction) of the read-channel amounts to M fish-bones. Then, as shown in FIG. 11 a for time moment “k”, for the pit-bits in the M fish-bones to the right hand side of the window W are set to an initial value; this initial value can be a constant value, or a value derived from some write-strategy table. First, the most right-positioned fish-bone F⁰ in the window W at moment “k” gets updated values for its pit-hole sizes (denoted by the array S⁰ₖ) hereby using the pit-hole radii of M fish-bones at its right hand side, and the pit-hole radii of M fish-bones at its left hand side. Then the same updating procedure is used for the 2nd most right-positioned fish-bone F¹ in the window at moment “k”; and so-forth, until the left-boundary of the window W has been reached. For a general fish-bone inside the window W, the pit-hole radii of pit-bits to its right hand side have been updated before (for the same position of the window, but during optimization of the pit-hole sizes in a preceding fish-bone), whereas the pit-hole radii of pit-bits to its left hand side have been updated for the previous position of the window W (at moment “k−1” if the current moment is “k”). So, for a given position “k” of the window W, the pit-hole sizes of the fish-bones denoted by the arrays S⁰ₖ, S¹ₖ₋₁ up to S^{N}_{k-N} are successively being determined through this optimization procedure that proceeds fish-bone-by-fish-bone.

After completion for the current position, the window W shifts one fish-bone to the right, and the optimization procedure starts all over again. This situation is shown in FIG. 11b for time-moment “k+1”.

The pit-hole sizes of a given fish-bone are thus iteratively updated according to the above procedure, with the number of iterations (or updates for a given fish-bone) equal to N+1. Only pit-hole sizes for non-zero bits are updated, the “0”-bits remain equal to the surrounding land. In FIG. 12 three situations for different pit-hole sizes to be optimized are shown. The central pit b₀ is the one of which the pit-hole size has to be updated. The pits bᵤ have already been updated for the current position of the window; the pits bₙ have not yet been updated for the current position of the window, but have been updated at a previous position of the window, or for the first iteration of the procedure, they have a pit-hole size from an educated guess, for instance from a write-strategy table. So, the pit-hole sizes from all the pits in a cluster of bits centered around the pit-bit bo to be updated are known. A 7-bit cluster has been used for convenience, but it might be any other (larger) cluster.

The pit-hole size of the central pit-bit is also known, e.g. its value from the previous position of the window, from the educated guess or from a table. With all this knowledge of pit-hole sizes, the pit-hole size of the central pit-bit b₀ can be updated. For instance, 2Nₚ+1 values of its pit-hole size can be considered, with a resolution or step size equal to “delta”, centered around the previous value of the pit-hole size. For each of these candidate pit-hole sizes, or for a limited subset of these candidate pit-hole sizes, centered around the previous value of the write parameter, the FoM, in fact the terms that depend on the value of the pit-hole size of the pit-bit that is varied, are evaluated. For the 7-bit cluster, these are the 7 HF-signal values around and including the central pit-bit b₀.

The (most probably linear) target that has been set (i.e. HF<target>) is known. The actual HF-signal value HF<channel> for each of the 7 locations around and including the central pit-bit are then derived by a channel model that depends on linear and non-linear ISI coefficients that are explicitly dependent on the pit-hole sizes of the pit-holes at the pit-bits of interest.

In the following first embodiment of the present invention using a parameter table (write strategy matrix) for the determination of the write parameters shall be explained. The case with 14 distinct cluster classes will be considered as a practical example for the subsequent description. Further, a ROM optical disc for 2D optical storage will be considered, where the write strategy matrix contains as a write-strategy parameter for each class the area of the surface of the corresponding pit-hole (if the central bit is a pit-bit). The write-strategy matrix is derived in the following optimization procedure. For a given write strategy matrix, a figure-of-merit (FoM) is defined based on the squared value of the difference between the read-out HF signal and the desired HF signal (which is due to the target linear interferences only); this squared difference is derived for each cluster class (averaged over all possible values for the 12 surrounding bits b₇, b₈, . . . , b₁₈ which determine the actual surfaces to be used for the neighbour pit-bits in the cluster class) and the sum over all classes multiplied with the corresponding multiplicity factor yields the final value for FoM, given by:

$$FoM = {\sum }_{i = 1}^{14} {\sum }_{bo = 0}^{1} {M}_{i} {\sum }_{b 7 = 0}^{1} {\sum }_{b 8 = 0}^{1} … {\sum }_{b 18 = 0}^{1} ( HF {b}_{0} ; {class}_{i} ) - {( {HF}_{lin} ( {b}_{0} ; {class}_{i } ) )}^{2}$$

where HF(b₀; classᵢ) has implicit dependence on the 12 next-neighbouring bits (b₇, b₈, . . . , b₁₈) and where the desired (target) linear HF signal Is given by:
HFₗᵢₙ(b₀; classᵢ)=1-b₀c₀−nᵢ c₁.

The coefficients c₀ and c₁ are the central tap and neighbour tap coefficients of the desired linear response. The parameter nᵢ is the number of neighbour pit-bits for class i. The figure-of-merit is a statistical average computed In a deterministic way by averaging over all possible cluster classes (2⁷ distinct cases) and all possibilities of their surrounding bits (2¹² distinct cases). Via the introduction of the cluster classes, the number of computations is largely reduced, however, the resulting figure-of-merit remains exactly identical.

FIG. 13 shows the 7 bits of a cluster together with the 12 surrounding bits b₇, b₈, . . . , b₁₈. FIG. 14 illustrates for a given cluster how the cluster classes of each pit-bit is determined (from the bit-values of its neighbour bits): for the central bit bo of the cluster, the bit-values of the cluster-bits are sufficient; for each of the neighbour bits in the cluster (bits b₂, b₃, . . . , b₆), 3 surrounding bits are required in order to uniquely determine its cluster class.

Given a performance criterion like the above figure-of-merit, the search for the optimum write strategy matrix is simply an optimization procedure in a N_{cl}-dimensional space (with N_{cl} the number of cluster classes used). Brute-force search procedures are not suitable because of the large dimensionality of the problem. Any sub-optimal optimization procedure (like steepest-descent etc.) will be sufficient.

A practical optimization procedure, that has been applied, considers a fixed number of distinct pit-hole surfaces. For each surface Sᵢ, the coefficients for linear interferences l₀[Sᵢ] and lₙ[S_{i] are computed; also all coefficients for self-interferences s}_{0,0}[Sᵢ] and s_{n,n}[Sᵢ], and all combinations for pit-hole surfaces Sᵢ and Sⱼ of the cross-interferences x_{0,n}[Sᵢ; Sⱼ] and x_{n,n}[Sᵢ; Sⱼ] have to be available too. From these parameters, the HF signal for any cluster with any possible pit-hole sizes out of the set of available pit-hole sizes can be computed. For each cluster, it is evaluated whether it is beneficial to decrease or increase the pit-hole-size of the central pit-symbol by a small amount (the step size used in the optimization); this procedure is performed for all clusters, after which it can be repeated in a number of subsequent iterations of the optmization procedure.

The basic principle of this embodiment is illustrated FIG. 15. At the input, the 2D bit-pattern that has to be written to the disc is provided. For each bit location (k,l), the information of the bit-cluster consisting of the central bit and its neighbour bits is retrieved. Next, it is analysed to which cluster class (denoted by pᵢ) the current cluster belongs. For the identified cluster class (at location (k,l)), the corresponding write parameters, for instance the size of the pit-hole for ROM mastering, is obtained from the write strategy matrix S. For a ROM system this matrix S contains the pit-hole sizes for the various basic cluster classes. This procedure is carried out for all bit-locations (k,l) when occupied by a pit-bit. It should be noted that it has been assumed here that a land-bit remains virginal, i.e. no pit-hole at all is mastered.

In a practical implementation a lattice parameter a=165 nm for NA=0.85 and λ=405 nm is considered, yielding a capacity increase over the BD-format of 1.4x. A write-strategy matrix has been derived in a simulation set-up based on scalar diffraction computations. In the optimization procedure, 40 possible pit-hole sizes with a surface ranging equidistantly from 0 up to 0.25πa² has been allowed. It has been observed that the linearized levels are very close to the target levels, illustrating the adequate performance of the write-strategy in linearizing the read-out signals.

With a larger modulation (minimum modulation level at 5%), larger pit-hole sizes are required on the average than for the case of a smaller modulation. It is further noted that the average pit-hole size is markedly smaller than in the original situation without write-strategy (with the fixed pit-hole diameter of 122.5 nm). The average pit-hole diameters for the two cases are: 97.8 nm and 106.0 nm. At this resolution in pit-hole radii (40 equidistant steps from zero to maximum pit-hole surface), cluster classes with the same value for n (the number of nearest neighbour pit-bits) show identical pit-hole radii, which makes the number of distinct entries in the write-strategy matrix even lower (reduction from 14 down to 7).

In a further implementation a lattice parameter a=138 nm for NA=0.85 and λ=405 nm is considered, yielding a capacity increase over the BD-format of 2x. The same procedure as described in the above paragraph is repeated, i.e. with pit-hole diameter b=102.5 nm for the two cases with 15% and 5% minimum modulation level. The average pit-hole diameters for the two cases are: 83.6 nm and 90.0 nm. Similar observations have been made as in the previous section, apart from two aspects: a) the pit-radii do not “cluster” according to the number of nearest pit-neighbours n; and b) the maximum pit-hole size scales as the size of the hexagonal bit-cell (with a factor of about 1.41) and the minimum pit-hole size scales down less fast (with a factor of 1.33).

For the ease of the description, the interferences have been limited to the first shell of nearest neighbours. To obtain a well-suited write-strategy for an increased capacity (like 2x BD), however, it is preferred to include at least the 2nd shell, which will lead to a larger number of entries in the write-strategy matrix. The average pit-hole size is markedly smaller than in the original situation without write-strategy (with fixed diameter b=102.5 nm, which may be favourable in view of the proximity effect in electron beam recording (EBR).

The invention is not limited to the 2D hexagonal lattice, but can also be applied to any type of 2D bit-lattice. Further, the invention is not limited to write-strategies that account for the interferences from the nearest neighbours (or first ring (or shell) of surrounding bits), but can be generalized to other (larger) sets of neighbouring bits. In an electron beam recorder, a write-strategy for minimization of the proximity effect (long-tail of write-impulse due to back-scattered electrons, can be up to 1 μm) may be required (certainly at high densities). The present proposal for linearization of the 2D channel may lead to a joint write-strategy, satisfying both purposes (that is linearization of the overall channel, and reduction of proximity-effects).

The “desired property” to be realized by the invention can be different from “linearization”. A possible candidate is to achieve a situation where the read-levels show a (much) reduced dependence on the two bits of the bottom row of a 7-bit hexagonal cluster. Such a situation is largely advantageous for a stripe-wise Viterbi bit-detector as described in European patent application 02292937 (PHNL021237EPP), in which a 2-row Viterbi-detector is used which shifts row-by-row from top to bottom of the broad spiral (consisting of more than 2 rows). In a known bit-detector the detector produces hard-decision or soft-decision information, and is used in an iterative way: this iterative processing is needed because the detector does not know in the first iteration the (probability of the) bits in the bit-row below a given (current) position of the stripe of the 2-row Viterbi-detector. Via a proper write-strategy, it is intended to reduce the impact of these two bits in the row “below”: in this way, the number of iterations required in the stripe-wise Viterbi detector will be reduced. As such, this procedure is then a substitute procedure for a two-dimensional version of decision-feedback equalization at the side of the read-channel. Further, a combined solution with a transmit filter and a receive filter is possible.

It is also possible to limit the resolution in pit-surface to only a few (e.g. 3) pit-sizes. Another viewpoint is to make the resolution in hardware not worse than the resolution that can be handled in the write process (e.g. the statistical variance in pit-size induced by a laser-beam recorder (LBR) or electron-beam recorder (EBR)).

According to the present invention write parameters for recording a pit-symbol of a symbol unit depend not only on the neighbouring symbols in the same symbol row at which the symbol under consideration is located, but in addition, depend also on the neighbouring symbols in the symbol rows above or below the symbol row at which the symbol under consideration is located. Thus, symbol values of symbols in neighbouring symbol rows determine partly the write parameters of a symbol in a given row, in order to achieve characteristics of the HF-signal of said symbol in said given row.

According to preferred embodiment of the present invention a solution is proposed to perform an “on-the-fly” optimization of the write parameters, in particular pit-hole sizes, for recording pits on a record carrier, taking into account the above described “chain-effect” where the size of one pit-hole at a given pit-bit is influenced by the chosen sizes of many neighbouring pit-holes. Instead of pit-hole sizes (for ROM), any set of parameters on which the write-channel (e.g. a set of laser-pulses for phase-change recording) may be based, can be optimized.

1. Method of determining write parameters for recording information on a record carrier, said information being in the form of a multi-dimensional channel data stream to be recorded as a channel band of at least two symbol rows one-dimensionally evolving along a first direction and aligned with each other along a second direction,
wherein the write parameters for recording a pit-symbol of a symbol unit of said channel data stream, a symbol unit comprising a central symbol and a number of neighbouring symbols of which some are located on the same symbol row as the central symbol and others are located on neighbouring symbol rows, are determined under joint consideration of
(i) the symbol value of the central symbol of the symbol unit;
(ii) the symbol values of the neighbouring symbols of the symbol unit located in the same symbol row as the central symbol of the symbol unit; and
(iii) the symbol values of neighbouring symbols of the symbol unit located in the symbol rows that are neighbouring the symbol row of the central symbol of the symbol unit.

2. Method as claimed in claim 1,
wherein said write parameters are determined by use of a parameter table containing the write parameters for all possible classes of symbol units, from which the write parameters for recording a pit-symbol of the symbol unit are selected according to the actual symbol unit.

3. Method as claimed in claim 1,
wherein said write parameters of said symbols are the pit-hole size, the characteristics of write pulses, in particular the number, the duration and/or the power level of write pulses, or the power level of a single write pulse.

4. Method of determining write parameters for recording information on a record carrier, in particular as claimed in claim 1, said information being in the form of a channel data stream to be recorded as a channel band of at least one symbol row one-dimensionally evolving along a first direction, wherein the write parameters are determined by an iterative procedure, said method comprising:
setting the write parameters for recording pit-symbols of said channel data stream to preliminary parameter values,
updating the preliminary parameter values by searching for the updated parameter values that best fulfil a predetermined criterion for the write parameters for recording of pit-symbols, said criterion being determined by the difference of HF-signal values, which will be determined by use of a channel model or obtained during read-out of pit-symbols recorded by use of the updated parameter values, and reference HF-signal values,
iterating said updating until a predetermined condition is fulfilled.

5. Method as claimed in claim 4,
wherein said predetermined criterion to be fulfilled for the write parameters is determined by the sum of absolute values of the differences of said HF-signal values and said reference HF-signal values.

6. Method as claimed in claim 4,
wherein said predetermined criterion to be fulfilled for the write parameters is determined by the sum of squared differences of said HF-signal values and said reference HF-signal values.

7. Method as claimed in claim 5,
wherein said sum comprises squared differences for all pit-symbols in a particular symbol area and wherein said sum shall be minimized during updating.

8. Method as claimed in claim 4,
wherein said predetermined condition is that the write-parameter for each pit-symbol has been updated for a predetermined number of times.

9. Method as claimed in claim 4,
wherein said predetermined condition, being a quality measure or figure-of-merit, is that is has reached a value below a predetermined threshold value.

10. Method as claimed in claim 4,
wherein said reference HF-signal values are obtained from a linear channel impulse response.

11. Method as claimed in claim 4,
wherein said HF-signal values and said reference HF-signal values are determined on the basis of said symbol units, each symbol unit comprising a number of nearest neighbouring symbols surrounding the central symbol.

12. Method as claimed in claim 11,
wherein said preliminary parameter values are derived from a parameter table containing the write parameters for all possible classes of symbol units.

13. Method as claimed in claim 11,
wherein in said updating step of the iteration the write parameters of the pit-symbols to be updated are updated subsequently symbol column by symbol column for a number of symbol columns defining a detection window, wherein the detection window is shifted after each iteration by at least one column in the tangential direction or said first direction of said channel band, whereby the write parameters of symbols in a new column that enters the detection window are set to initial predetermined values, and wherein the iterations are repeated for a given column until said column is shifted outside of said detection window.

14. Device for determining write parameters for recording information on a record carrier, said information being in the form of a multi-dimensional channel data stream to be recorded as a channel band of at least two symbol rows one-dimensionally evolving along a first direction and aligned with each other along a second direction,
wherein the write parameters for recording a pit-symbol of a symbol unit of said channel data stream, a symbol unit comprising a central symbol and a number of neighbouring symbols of which some are located on the same symbol row as the central symbol and others are located on neighbouring symbol rows, are determined under joint consideration of
(i) the symbol value of the central symbol of the symbol unit;
(ii) the symbol values of the neighbouring symbols of the symbol unit located in the same symbol row as the central symbol of the symbol unit; and
(iii) the symbol values of neighbouring symbols of the symbol unit located in the symbol rows that are neighbouring the symbol row of the central symbol of the symbol unit.

15. Device for determining write parameters for recording information on a record carrier, in particular as claimed in claim 14, said information being in the form of a channel data stream to be recorded as a channel band of at least one symbol row one-dimensionally evolving along a first direction, wherein the write parameters are determined by an iterative procedure, said device comprising:
a setting means for setting the write parameters for recording pit-symbols of said channel data stream to preliminary parameter values,
an updating means for updating the preliminary parameter values by searching for the updated parameter values that best fulfil a predetermined criterion for the write parameters for recording of pit-symbols, said criterion being determined by the difference of HF-signal values, which will be determined by use of a channel model or obtained during read-out of pit-symbols recorded by use of the updated parameter values, and reference HF-signal values,
an iteration means for iterating said updating until a predetermined condition is fulfilled.

16. Recording method for recording information in the form of a channel data stream on a record carrier, said information being recorded as a channel strip of at least one symbol row one-dimensionally evolving along a first direction, wherein pit-symbols are recorded by use of write parameters which are determined by a method as claimed in claim 1.

17. Recording apparatus for recording information in the form of a channel data stream on a record carrier, said information being recorded as a channel strip of at least one symbol row one-dimensionally evolving along a first direction, said recording apparatus comprising means for recording pit-symbols by use of write parameters and a device for determining write parameters for recording information on an optical record carrier as claimed in claim 14.

18. Computer program comprising program code means for causing a computer to perform the steps of the methods as claimed in claim 1 when said computer program is executed on a computer.

19. Record carrier on which pit-symbols have been recorded by use of the method as claimed in claim 16, the information being recorded in the form of a channel data stream as a channel band of at least one symbol row one-dimensionally evolving along a first direction.
